(19) United States
(12) Patent Application Publication
(10) Pub. No.: US 2003/0066900 A1
(43) Pub. Date: Apr. 10, 2003

(54) Fuel injection valve

(76) Inventor: Guenter Dantes, Eberdingen (DE)

Correspondence Address: KENYON & KENYON, ONE BROADWAY, NEW YORK, NY, 10004, US

(21) Appl. No.: 10/130,657

(22) PCT Filed: Aug. 25, 2001
(86) PCT No.: PCT/DE01/03267

(30) Foreign Application Priority Data
Sep. 19, 2000 (DE) 100 46 305.3

(51) Int. Cl. F02D 1/06

(52) U.S. Cl. 239/5; 239/533.12; 239/533.11; 239/492; 239/494

(57) ABSTRACT

A fuel injector, for example, for the direct injection of fuel into the combustion chamber of a mixture-compressing internal combustion engine with externally supplied ignition is provided, including a valve-seat member, into which grooves are introduced upstream from a valve-seat surface, and a guide disk, which cooperates with the grooves of valve-seat member to form closed swirl channels. The swirl channels discharge with a tangential component into a swirl chamber, where the inflowing fuel obtains a velocity component in the circumferential direction given an open fuel injector.

### BACKGROUND INFORMATION

The present invention is directed to a fuel injector of the type set forth in the main claim.

Fuel injectors having a swirl-generating assembly are known from the German patent DE 197 36 682 A1. They have a flat swirl plate into which grooves have been introduced. In these grooves, which have been closed by a guide plate and by the valve-seat body to form swirl channels, the fuel flows to a central opening, obtaining a circumferential velocity due to a tangential component of the grooves. To allow the inflow of the fuel into the swirl plate, the guide disk has a peripheral phase at the outside diameter.

From the German patent DE 196 25 059 A1, another fuel injector is known where the swirl generation is also generated upstream from the sealing seat. The fuel channels, which are used for fuel metering as well, are introduced into the valve-seat member—which is simultaneously used to guide the valve needle—by drilling in such a manner that the fuel is fed radially in the direction of the spray-discharge orifice, the fuel channels having a tangential component as well as an axial component.

Furthermore, from the German patent 36 43 523 A1 a fuel injector having an insertion member above the sealing seat is known. Bore holes introduced into the insertion member are used for swirl generation. After emerging from the swirl channels, the fuel flows into a swirl chamber formed by the insertion member and the sealing surface. Given an open valve, the pressure decreases at the insertion body, due to the throttling of the flow in the swirl channels, which is used to generate a sealing surface pressure.

In the mentioned fuel injectors, the swirl is generated either by the introduction of bore holes, in which case a modification of the flow cross-section along the flow path is not possible, or by the use of an additional component in the form of a swirl plate. Using several components having manufacturing tolerances is particularly problematic here, since this yields different results in the fuel metering and the formation of a spray cone. From a standpoint of production engineering, the use of several components is disadvantageous.

A further disadvantage of the swirl plate from DE 197 36 682 A1 are the burrs created during stamping of the disk, which require an expensive reworking to remove the burrs. Moreover, the multiple-part design of the swirl-generating assembly has a higher likelihood of errors occurring during installation of the fuel injector, which requires several individual steps.

Furthermore, in the fuel injector in DE 36 43 523 A1 it is disadvantageous that a sealing surface pressure between the insertion member and the valve-seat surface is given only when the fuel injector is open, since the flow formation causes the generation of a corresponding force.

### SUMMARY OF THE INVENTION

The fuel injector according to the present invention, having the characterizing features of Claim 1, and the method of the present invention, having the features of Claim 10, have the advantage over the related art that the working of the grooves occurs through the working of one surface. The grooves are formed into closed swirl channels by the welding of a cover. This allows not only an easy modification of the swirl-channel geometry, but also a change in the cross-section within a channel. In this way, it is easy to accommodate various customer specifications regarding the metered fuel injection quantity and spray geometry. Despite the simple manufacture of a large quantity of different variants, the use of the utilized identical parts remains constant.

Moreover, the position and contour of the grooves after working of the component can be monitored before the closed swirl channels are produced by placing the cover. In this manner, it is possible to detect defective parts outside of the actual installation procedure of the fuel injector, so that the number of rejected fuel injectors is reduced.

Furthermore, the welding of the guide plate to the valve seat member produces a compact structural component, which may be treated as one part in the further manufacturing process. This makes it possible to grind the guide disk together with the valve-seat body in correct order. Positional tolerances between valve-seat surface and the central opening of the guide plate may thus be prevented. By treating the structural component as one part, the number of error sources during the subsequent assembly steps of the fuel injector is reduced as well.

The features set forth in the dependent claims make possible advantageous developments of the fuel injector recited in Claim 1 and the method recited in Claim 10.

Due to the burr-free working of the openings, no reworking will be necessary, such as is required, for instance, when the fuel channels are drilled. Costs are saved by omitting one processing step.

By using processing methods which do not cause any thermal deformation in the valve-seat body, the quality of the introduced grooves is consistently high, and a defined surface contour is ensured to form a sealing surface with respect to the guide plate.

It is also advantageous that the guide plate need not be guided radially through the nozzle body. As a result, the introduction of fuel channels into the guide plate to supply fuel to the swirl channels may be omitted.

### BRIEF DESCRIPTION OF THE DRAWINGS

Exemplary embodiments of the invention are shown simplified in the drawing and elucidated in greater detail in the following description. The figures show:

FIG. 1: a schematic section through a fuel injector according to the present invention;

FIG. 2: a schematic section of a detail II of FIG. 1 through an embodiment of a fuel injector according to the present invention; and

FIG. 3: a top view of a valve-seat member of a fuel injector according to the present inventing, with introduced grooves.

### DESCRIPTION OF THE EXEMPLARY EMBODIMENT

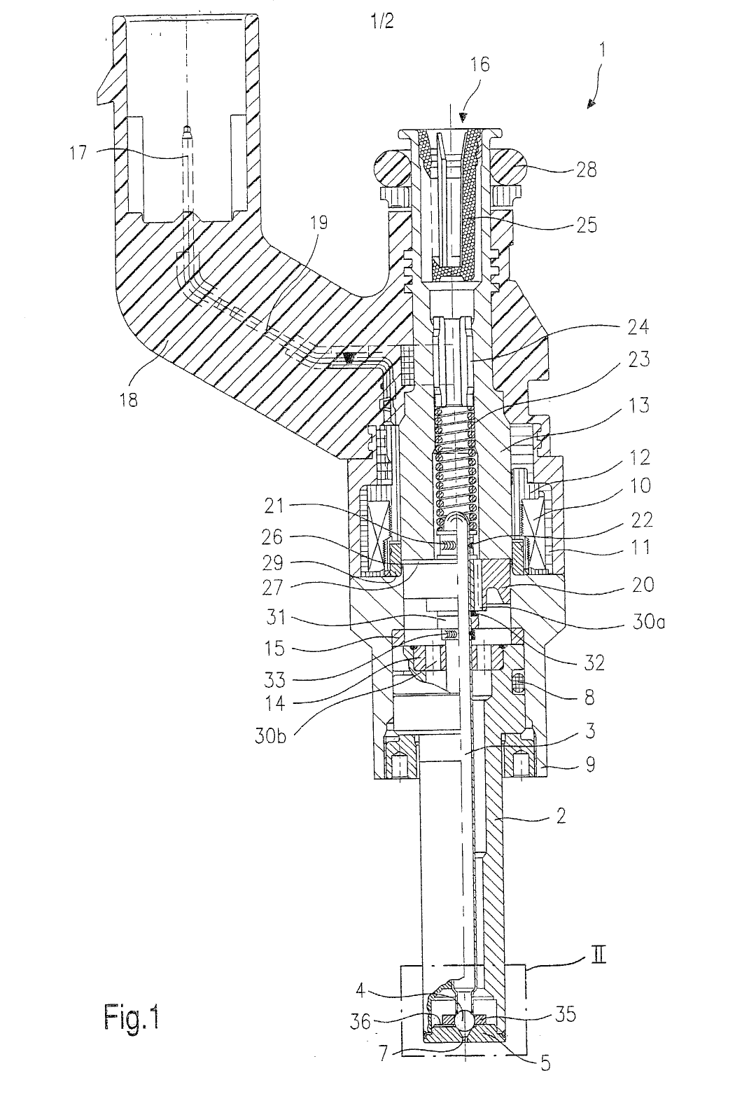

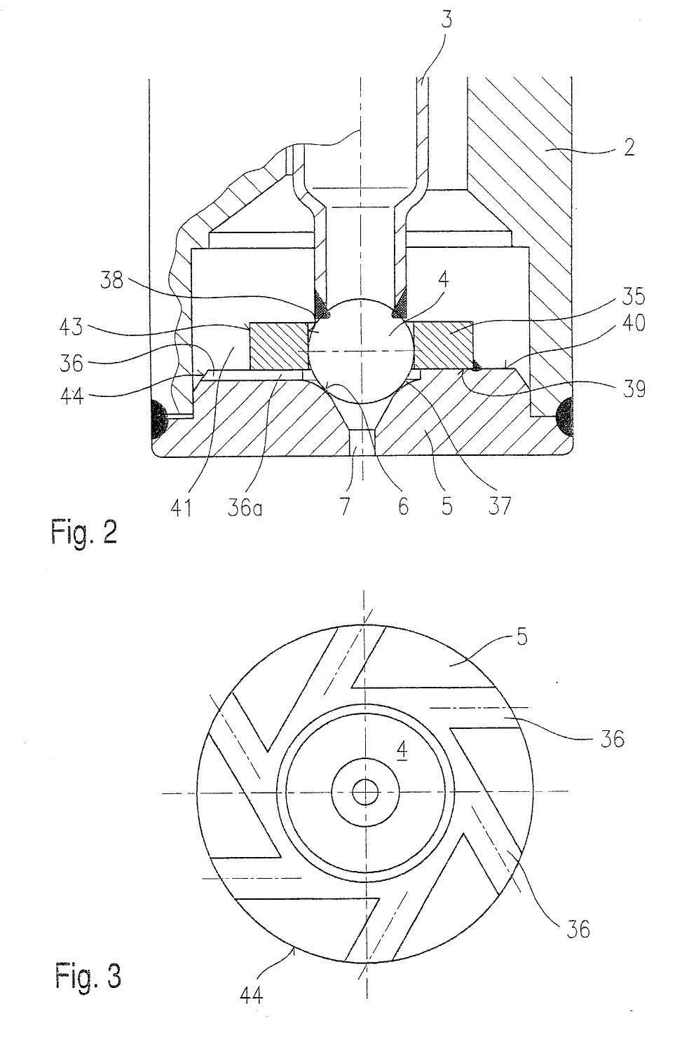

Before an exemplary embodiment of a fuel injector 1 or of a valve-seat member 5 according to the present invention is described more precisely with reference to FIGS. 2 and 3, to better understand the present invention, fuel injector 1 shall first of all be briefly explained in an overall representation with respect to its important components, on the basis of FIG. 1.

Fuel injector 1 is designed in the form of an injector for fuel-injection systems of mixture-compressing internal combustion engines with externally supplied ignition. Fuel injector 1 is particularly suitable for directly injecting fuel into a combustion chamber (not shown) of an internal combustion engine.

Fuel injector 1 includes a nozzle body 2, in which a valve needle 3 is positioned. Valve needle 3 is connected in operative connection to a valve-closure member 4 that cooperates with a valve-seat surface 6, arranged on a valve-seat member 5, to form a sealing seat. Fuel injector 1 in the exemplary embodiment is an inwardly opening, electro-magnetically operated fuel injector 1 which has a spray-discharge orifice 7. Nozzle body 2 is sealed from external pole 9 of a magnetic coil 10 by a seal 8. Magnetic coil 10 is encapsulated in a coil housing 11 and wound on a bobbin 12, which lies adjacent to an internal pole 13 of magnetic coil 10. Internal pole 13 and external pole 9 are separated from each other by a gap 26 and are supported on a connecting component 29. Magnetic coil 10 is energized via an electric line 19 by an electric current, which can be supplied via an electrical plug-in contact 17. Plug-in contact 17 is enclosed in a plastic jacket 18, which may be sprayed onto internal pole 13.

Valve needle 3 is guided in a valve needle guide 14, which is designed as a disk. A paired adjustment disk 15 is used to adjust the (valve) lift. An armature 20 is on the other side of adjustment disk 15. It is connected by force-locking to valve needle 3 via a first flange 21, and valve needle 3 is connected to first flange 21 by a welded seam 22. Braced against first flange 21 is a return spring 23 which, in the present design of fuel injector 1, receives an initial stress from a sleeve 24.

A second flange 31, which is connected to valve needle 3 via a welded seam 33 as well, is used as lower armature stop. An elastic intermediate ring 32, which lies upon second flange 31, avoids bounce when fuel injector 1 is closed.

Fuel channels 30a, 30b and grooves 36, respectively, run through valve needle guide 14, armature 20 and valve seat member 5, which conduct the fuel, supplied via central fuel supply 16 and filtered by a filter element 25, to spray-discharge orifice 7 in valve-seat member 5. Fuel injector 1 is sealed by seal 28 from a distributor line (not shown).

In the neutral position of fuel injector 1, return spring 23 acts upon armature 20 counter to its lift direction in such a way that valve-closure member 4 is retained in sealing contact against valve-seat surface 6. Upon excitation of magnetic coil 10, the latter generates a magnetic field which moves armature 20 in the lift direction, counter to the spring force of return spring 23, the lift being predefined by a working gap 27 existing in the neutral position between internal pole 13 and armature 20. Armature 20 also carries along in the lift direction first flange 21, which is welded to valve needle 3. Valve-closure member 4, being operatively connected to valve needle 3, lifts off from valve seat surface 6, and fuel guided via fuel channels 30a, 30b and grooves 36, respectively, to spray-discharge orifice 7 is sprayed off.

When the coil current is switched off, after sufficient decay of the magnetic field, armature 20 falls away from internal pole 13 because of the pressure of return spring 23 on first flange 21, whereupon valve needle 3 moves in a direction counter to the lift. In this manner, valve-closing body 4 rests on valve-seat surface 6 and fuel injector 1 is closed.

In fuel injector 1 designed according to the present invention, a swirl of the fuel is generated by feeding the fuel into a swirl chamber 37 into which grooves 36, which are used to supply the fuel, open with a tangential component. To be able to reproduce the metering of a defined fuel quantity, a guide disk 35 is mounted at the topside of valve-seat member 5, as shown in FIG. 2, by which grooves 36 in valve-seat member 5 are supplemented to form closed swirl channels 36a having defined cross-sections.

Guide disk 35 is disk-shaped and provided with a cut-out 38, in which valve-closure member 4 is guided. Compared to the diameter of preferably spherical valve-closure member 4, cut-out 38 of guide disk 35 is toleranced such as to prevent the formation of an auxiliary current path between valve-closure member 4 and guide disk 35. The radial extension of guide disk 35 is less than the inner diameter of nozzle body 2. The fuel supplied via fuel channels 30a, 30b, flows through a gap 41, formed between guide disk 35 and nozzle body 2, into grooves 36. Downstream-pointing bottom side 39 of guide disk 35 has a shape that corresponds to that of upstream-pointing surface 40 of the valve-seat member, so that the formation of a gap between guide disk 35 and valve-seat member 5 is prevented. Grooves 36 have been introduced into top surface 40 of upstream-pointing valve-seat member 5, which may differ not only in their position with respect to center axis 42 of fuel injector 1, but also in their width and depth. In the direction of flow, grooves 36, which have a preferably straight or curved design, discharge in the flow direction into a swirl chamber 37 centrally located in valve-seat member 5, which transitions into valve-seat surface 6. The radial extension of grooves 36 is greater than the radial extension of guide disk 35. Grooves 36 may also be brought radially out of valve-seat member 5, as shown in FIG. 3, and discharge at a chamfer of valve-seat member 5. Located downstream from valve-seat surface 6 is at least one spray-off bore 7. Here, the outward extension of grooves 36 in the radial direction projects beyond outer edge 43 of guide disk 35, so as to facilitate the influx of fuel into swirl channels 36a.

Upstream from valve-seat surface 6 is annular swirl chamber 37, which is formed by valve closure member 4, valve-seat member 5 and guide disk 35. At the beginning of the injection process, the low volume of swirl chamber 37 while fuel injector 1 is closed causes merely the low volume filled with fuel to be sprayed off, without a swirl being formed. According to the method of the present invention, grooves 36 may be introduced once valve-seat member 5 has hardened, this being accomplished by electro-chemical metal working or eroding, for instance. To form closed swirl channels 36a, guide disk 35 is subsequently mounted on valve-seat member 5, by welding, for example. The structural component thus composed of valve-seat member 5 and guide disk 35 may be jointly worked further. A joint grinding of cut-out 38 of guide disk 35 and valve-seat surface 6 prevents a displacement of the center line of valve-seat member 5 and guide disk 35, which reduces the wear of fuel injector 1.

What is claimed is:

1. A fuel injector (1) for fuel injection systems of internal combustion engines, having a valve-seat member (5), which has a valve-seat surface (6) cooperating with a valve-closure member (4) to form a sealing seat, and having a guide disk (35) provided with a central cutout (38) in which the valve-closure member (4) is guided, and at least one swirl channel (36a) upstream from the valve-seat surface (6), to generate a swirl of a fuel jet sprayed off by fuel injector (1), wherein, on a surface (40) located upstream from the valve-seat surface (6), the valve-seat member (5) is provided with one or a plurality of grooves (36), which are closed by the guide disk (35) to form one or a plurality of swirl channels (36a).

2. The fuel injector as recited in claim 1, wherein the swirl channels (36a) discharge into a swirl chamber (37) located above the valve-seat surface (6).

3. The fuel injector as recited in claim 1 or 2, wherein the swirl channels (36a) have a tangential component at their opening into the swirl chamber (37).

4. The fuel injector as recited in one of claims 1 through 3, wherein the grooves (36) may have a straight or curved design.

5. The fuel injector as recited in one of the claims 1 through 3, wherein the grooves (36) run in a curved manner.

6. The fuel injector as recited in one of the claims 1 through 5, wherein the grooves (36) have different widths and depths.

7. The fuel injector as recited in one of claims 1 through 6, wherein the outside diameter of the guide disk (35) is smaller than the inner diameter of a nozzle body (2), into which the guide disk (35) is inserted.

8. The fuel injector as recited in one of claims 1 through 7, wherein the extension of the grooves (36) is greater in the radial direction towards the outside than the outer edge (43) of the guide disk (35).

9. The fuel injector as recited in one of claims 1 through 6, wherein, in the radial direction, the grooves (36) discharge on the outside at a chamfer (44) of the valve-seat member (5).

10. A method for introducing swirl channels (36a) into a valve-seat member (5) of a fuel injector (1) for fuel-injection systems of internal combustion engines to generate a swirl of a fuel jet sprayed off by the fuel injector (1), the valve-seat member (5) having a valve-seat surface (6) which cooperates with a valve-closure member (4) to form a sealing seat, and the fuel injector (1) having a guide disk (35) which is provided with a central cutout (38) in which the valve-closure member (5) is guided, including the following method steps:
introduction of a predefined number of grooves (36) into an upstream-pointing surface (40) of the valve-seat member (5);
arranging the guide disk (35) as cover on the valve-seat member (5); and
joining the guide disk (35) to the valve-seat member (5).

11. The method as recited in claim 10, wherein the valve-seat member (5) is hardened before the grooves (36) are introduced.

12. The method as recited in claim 10 or 11, wherein the grooves (36) are introduced in a non-contact manner into the valve-seat member (5) by electro-chemical metal cutting.

13. The method as recited in claim 10 or 11, wherein the grooves (36) are eroded into the valve-seat member (5).

14. The method as recited in one of claims 10 through 13, wherein after joining, the guide disk (35) and the valve-seat member (5) are worked jointly.
